(19) United States
(12) Patent Application Publication
(10) Pub. No.: US 2007/0250500 A1
(43) Pub. Date: Oct. 25, 2007

(54) Multi-directional and auto-adaptive relevance and search system and methods thereof

(75) Inventor: Emil Ismalon, Yad Rambam (IL)

Correspondence Address: SUGHRUE MION, PLLC, 2100 PENNSYLVANIA AVENUE, N.W., SUITE 800, WASHINGTON, DC, 20037, US

(73) Assignee: Collarity, Inc., Palo Alto, CA (US)

(21) Appl. No.: 11/633,461

(22) Filed: Dec. 5, 2006

Related U.S. Application Data
(60) Provisional application No. 60/741,902, filed on Dec. 5, 2005.

(51) Int. Cl. G06F 17/30

(52) U.S. Cl. 707/5; 707/E17.108

(57) ABSTRACT

The multi-directional and auto-adaptive relevance and search methods hereof are capable of clustering information and users in ways that allow for higher quality search results to be provided to all the users of the system. As part of the operation of the search engine, both information pages and users are clustered in meaningful ways using multi-layer association graphs. Specifically, a multi-directional approach is used to allow the transfer of information from the users to the information pages in addition to the traditional transfer of data from the information pages to the user. The clustering is performed with respect to the identification of clusters of plurality of users that enables the information pages clustering in a dynamic way providing additional refinements beyond user profiles. Furthermore, the system is configured to provide personalized advisory by presenting additional search phrases tailored to the searching user.

### CROSS-REFERENCES TO RELATED APPLICATIONS

The present application claims the benefit of U.S. Provisional Application 60/741,902, filed Dec. 5, 2005, entitled, “Multi-directional and auto-adaptive relevance and search system and methods thereof,” which is assigned to the assignee of the present application.

### FIELD OF THE INVENTION

The present invention relates generally to a system for information search and more specifically to a system and methods thereof for multi-directional and auto-adaptive search.

### BACKGROUND OF THE INVENTION

Performing a search for the purpose of retrieval of information from the Internet or the world-wide web (WWW) has become a fundamental tool for practically every person using a computer. Using a variety of search tools, a user can reach vast amounts of data and select that data which seemingly fits the specific search criteria. The search is usually performed by providing one or more words, or a search phrase that may contain Boolean operators in addition to keywords, that is used to access the network. Probably the best known and widely used search tools today are provided by Google, Inc. and Yahoo, Inc., each having its own benefits.

As noted, the user of the search engine provides a search phrase and based on that the engine returns a list of documents from which the user can then select those seemingly most fitting the search needs. In a typical response, the documents are ordered in some kind of a descending order according to some preset criteria made by the search engine provider. There are multiple ways of providing such a descending list in an attempt to provide meaningful results to the users performing the search. Because of the inherent nature of the static ranking systems, a document appearing at a high priority may not match well the skill set of the searcher or vice versa. For example, a software engineer looking for Java (software) and a traveler looking for Java (island), will receive the very same results for a query having the same key words, or search phrase.

Notably, there exists certain search engines, such as the one provided by AOL, Inc., where a user profile is used to attempt to provide a more accurate search result based on certain static characteristics of a user. This information may include information such as the searcher's age, location, job, education and the likes. A key deficiency is that there is an assumption that the user will update the changes over time, or that the user may have higher or lesser expertise than the indicators provided by such a profile may point to. Moreover, it is impossible to capture the vast diversity of the user from such profiles. Therefore, regardless of the approach taken, the user is faced with a list of usually hundreds or thousands of items to select from, which are rarely tailored to the specific needs of the user performing the search.

According to prior art solutions, universal resource locators (URLs) ranking is performed, i.e., certain URLs that enable the connection to specific web pages are presented to the user earlier than others, for example by placing them closer to the top of the list of URLs. However, ranking is a highly subjective feature, and therefore sensitive to the user preferences and skill within a certain topic. A certain webpage that may be highly relevant to an expert or more experienced user performing the search, might be poorly represented or otherwise poorly ranked, higher or lower, to a novice performing the search for the same kind of information. Commonly the ranking is a query dependent attribute and therefore different queries for the same information may result in a different ranking of the pages although the target requested information is the same. Furthermore, search engines are configured to rank URLs based on a single keyword. However, when presented with a multi-word search phrase, i.e., two or more keywords, merge algorithms are used. Basically, the top listed URLs for each keyword are used to create the merged ranked URL list. Performing a contextual analysis using the keywords of the specific query in real-time, although significantly more accurate and meaningful to the user, is a daunting task, significantly beyond the capabilities of current computational solutions. Moreover, within set of results there are different branch or webpage clusters that address different topics. Merely displaying those results in the URL ranked list is generally an artificial process, and not indicative of what would be the more likely rank the user would appreciate.

Methods for collaborative filtering (CF) are sometimes applied in an explicit manner, by using social networks, forums, communities or other types of groups creation as a method to supply more relevant information. Shortcomings of such explicit collaboration are well known, including lack of credibility of information supplied by group members, as well as insufficient context-based similarity in the case of social networks or communities, and, in most cases, predefined (almost static) groups.

### SUMMARY OF THE INVENTION

It would be therefore advantageous if a system would be provided that is capable of addressing the limitation of prior art search engines. Specifically it would be advantageous if such system would tailor the results provided to a search phrase in a manner that would be most suitable to the person performing the search. It would be further advantageous if such a system could tailor the results with respect to a user interest and behavior in a specific area, and information provided to such a user, based not only on the individual search characteristics determined for the user, but rather also including intrinsically the influence of the characteristics of other users that have similar associations (likeminded) regarding a certain topic, and have similar interaction patterns with the plurality of available information pages. It would be furthermore advantageous if such a system would adapt itself over time to the changing characteristics of the user or group of users, as well as the changing characteristics of the information pages made available through the search system. Specifically, it would be further advantageous if an advisory of keywords would be provided to the searching user that is tailored to the individual search characteristics and influenced also by groups to which a user is associated based on search and usage characteristics.

The multi-directional and auto-adaptive relevance and search methods hereof are capable of clustering information and users in ways that allow for higher quality search results to be provided to all the users of the system. As part of the operation of the search engine, both information pages and users are clustered in meaningful ways using multi-layer association graphs. Specifically, a multi-directional approach is used to allow the transfer of information from the users to the information pages in addition to the traditional transfer of data from the information pages to the user. The clustering is performed with respect to the identification of clusters of plurality of users that enables the information pages clustering in a dynamic way providing additional refinements beyond user profiles. Furthermore, the system is configured to provide personalized advisory by presenting additional search phrases tailored to the searching user.

### BRIEF DESCRIPTION OF FIGURES

FIG. 1 is a block diagram of a user system configured in accordance with the disclosed invention;

FIG. 2 is a schematic diagram of a network connected to a search engine server, in accordance with the disclosed invention;

FIG. 3 is a schematic diagram of the clustering performed in accordance with the disclosed invention;

FIG. 4 is a flowchart showing the steps of a search as performed in accordance with the disclosed invention;

FIG. 5 is a flowchart showing the steps for displaying associated search phrases;

FIG. 6 is an example of a compact association graph, in accordance with the disclosed invention;

FIG. 7 is a table of the index word association, in accordance with the disclosed invention;

FIG. 8 is a schematic description of the user-document interaction model, in accordance with the disclosed invention;

FIG. 9 is a schematic diagram of the process of creating primary indexes from a plurality of personal association graphs;

FIG. 10 is a flowchart depicting the creation of a personal association graph;

FIG. 11 is a flowchart showing the process of creating a new primary index from a primary index and a secondary index;

FIG. 12 is a diagram of primary indexes created from earlier primary indexes;

FIG. 13 is a flowchart showing the process of providing keyword advice to a user;

FIG. 14 is a flowchart for the use of association graphs for the purpose of ranking information pages tailored to a searching user;

FIG. 15 is a flowchart describing the process of comparing a query-specific association graph to a query-specific URL graph;

FIG. 16 is an exemplary matrix of a query personal association graph matrix; and

FIG. 17 is an exemplary table of a query URL association graph matrix.

### DETAILED DESCRIPTION OF EMBODIMENTS

The multi-directional and auto-adaptive relevance and search system and methods hereof are capable of clustering information and users in ways that allow for higher quality (relevant and personalized) search results to be provided to all the users of the system. As part of the operation of the relevance and search system, both information pages and users are clustered in meaningful ways using multi-layer association graphs. Specifically, a multi-directional approach is used to allow the transfer of information from the users to the information pages in addition to the traditional transfer of data from the information pages to the user. The clustering is performed with respect to the identification of clusters of plurality of users of the system that enables the clustering of information pages in a dynamic way providing additional refinements beyond user profiles. Furthermore, the system is configured to provide personalized advisory by presenting additional search phrases tailored to the searching user. Key to the invention is a mapping of a user based on the search phrases used by the user, the search phrases used by other users, and those keywords in documents to which the user was exposed.

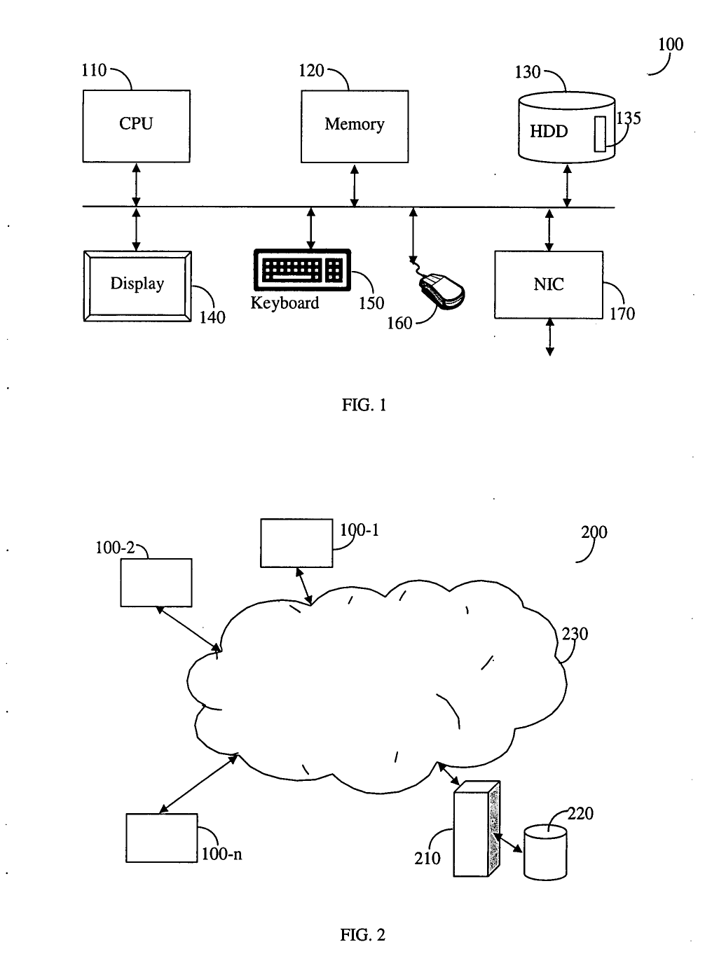

Reference is now made to FIG. 1, which shows an exemplary and non-limiting block diagram of a user system 100, configured in accordance with the disclosed invention. User system 100 comprises a central processing unit (CPU) 110, system memory 120, a non-volatile memory such as the hard disk drive (HDD) 130, a display 140, input and output means such as keyboard 150 and mouse 160, and a network interface card (NIC) 170. In one embodiment of the disclosed invention, HDD 130 further comprises an agent 135, typically a utility that enables the functioning of user system 100 for the purposes disclosed in the invention. In another embodiment of the disclosed invention, HDD 130 further comprises a link to a page configured to enable searches in accordance with the disclosed invention, and as further discussed in more detail below.

NIC 170 connects via means of a communication connection 175, for example, but not limited to, Ethernet, to a network enabling access to a search engine. In a typical network system a plurality of user systems 100, for example user system 100-1 through 100-n are connected to a network, for example network 230, as shown in the exemplary and non-limiting FIG. 2. Network 230 may include, but is not limited to, a local area network (LAN), wide area network (WAN), the world wide web (WWW), the likes, and any combinations thereof. Also connected is an auto-adaptive search (AAS) server 210 configured in accordance with the disclosed invention. AAS server 210 further comprising a non-volatile memory such as HDD 220. AAS server 210 and HDD 220 are configured to be operative in the manner described herein below to achieve the goals of the disclosed invention. Specifically, HDD 220 may contain an implementation of the methods disclosed herein. In one embodiment of the disclosed invention AAS server 210 further comprises a search engine. In another embodiment of the disclosed invention, an external search engine is used for the purpose of performing the actual data mining for the search purposes.

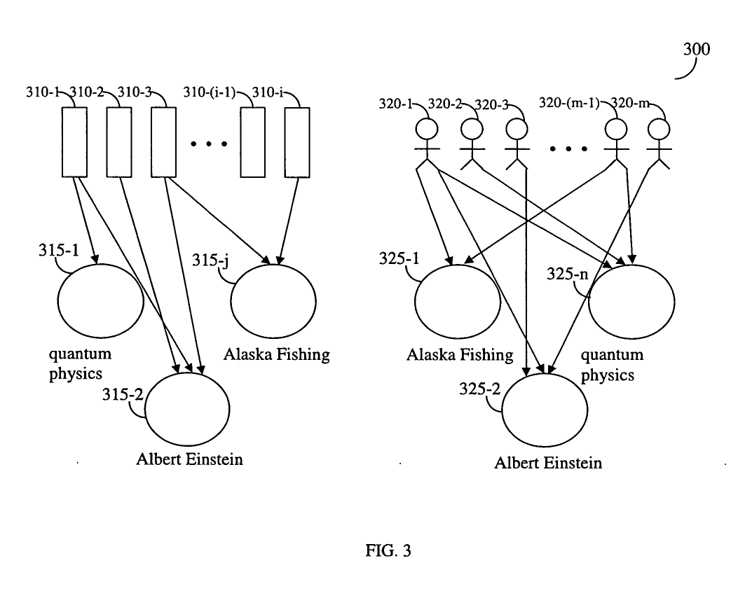

A key element in accordance with the disclosed invention is the ability to cluster both users as well as information in respective clusters. Reference is now made to FIG. 3, which shows an exemplary and non-limiting schematic diagram of the clustering performed in accordance with the disclosed invention. A plurality of information pages available on the web, for example, are examined and determined to belong to various clusters. For example, a page 310-1 may be fully suitable to fit for both clusters of Albert Einstein 315-2 and quantum physics 315-1, while information page 310-2 is clustered to only Albert Einstein 315-2. Another page, for example information page 310-3, may fit the category of Alaska fishing 315-j and at the same time also belong to Albert Einstein 315-2. Therefore, a plurality of clusters identified by the level of interest and preferences, demonstrated for the page may be created. The details of the creation of such clusters are discussed in more detail below. Similarly, based on the behavior of the person performing a search, the user may be clustered into specific clustering categories. For example, user 320-1 may be searching for Alaska fishing 325-1 as well as for quantum physics 325-n. The clustering takes place periodically as part of the operation of AAS server 210, therefore dynamically creating new and updated clusters of all types. When a search is performed by a user, for example by user 320-3, clustered under Alaska fishing 325-2, and assuming the search phrase has to do with fishing, then the Alaska fishing cluster fits user 320-3 and therefore the information pages 310-3 and 310-i will be shown to that user. This association was created not only from the specific search by user 320-3, but as a result of the search of a plurality of users using the disclosed system. Hence, not only the individual characteristics of a searching user are used to provide meaningful information are used, but also the influence of the plurality of users similar to the searching user, for example user 320-3, are used, and as a result a better search report is provided. Furthermore, additional levels of clustering may be achieved and therefore clusters of various cluster groups can also be created allowing for providing a better response to a user's search phrase.

In one embodiment of the disclosed invention the clustering of the user is actually performed and maintained on the user system 100 by agent 135. In another embodiment of the disclosed invention, only the data collection is performed at the user system 100, predominately for the purpose of securing the user's privacy, and only relevant parameters for user clustering are transferred to AAS server 210 for the purpose of performing the clustering functions discussed above.

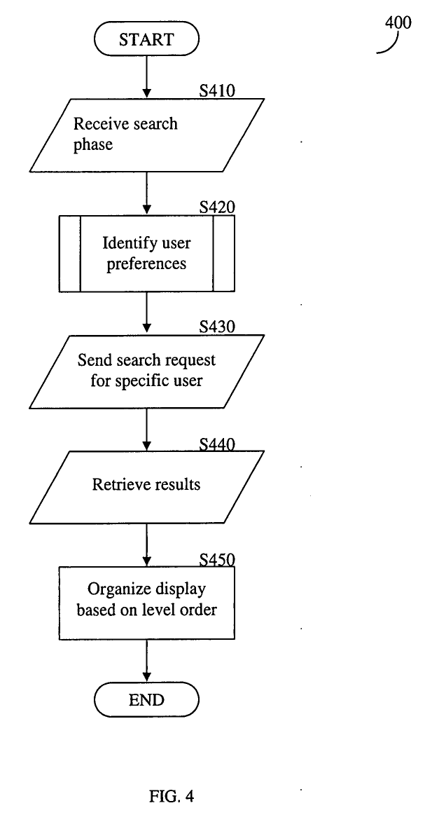

An exemplary and non-limiting search session is discussed with reference to FIG. 4. In step S410 a search phrase is received by AAS server 210. In step S420 the user's level of interaction or competence, generally referred to as the user preference, in the area of search, is determined. Level of interaction can be measured by the amount of time spent interactively in the page or linked pages, the number of times the page was accessed by the user, and other parameters indicative of the level of interactivity. It is more difficult to determine the level of competence. In step S430 the search is performed using the clustering discussed above and in step S440 results are retrieved, the results being pertinent to the user's clustering as well as the clustering of the topics searched for, and as discussed above. In step S450 the display of the search results is organized according to a score to allow for higher quality results to be displayed first to the user.

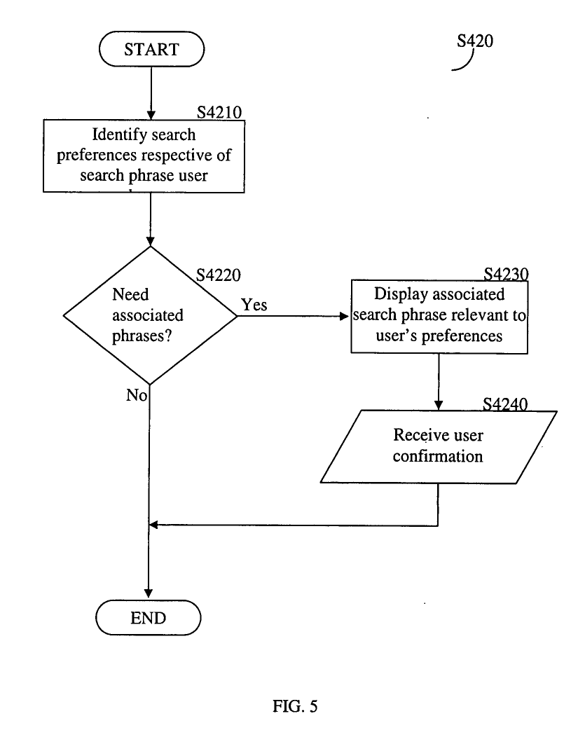

With reference to FIG. 5, there is discussed in more detail an exemplary and non-limiting embodiment of step S420. In step S4210 the level of preference of a user in respect to a search phrase is determined. In step S4220 it is checked whether additional associated phrases are to be displayed and if not execution ceases; otherwise, execution continues with step S4230. In step S4230 search phrases associated with the provided search phrase are displayed. A method for providing such associated search phrases is discussed in more detail below. The associated search phrases take into consideration the clustering of both the information pages as well as the users allowing for more accurately suggesting possible search phrases to be used by the user for the performance of a better search. In step S4240 a user confirmation for the use of an additional or alternative search phrase from the displayed list of associated search phrases is received.

In one embodiment of the disclosed invention an advisory information is displayed, for example, as a list. The advisory list contains search phrases found to be relevant to users performing the search of the type the searching user has performed. The search phrases are refined based on additional associations that are extracted from several resources, personal association graph, topic association graph, personal groups association graphs, global association graphs, pre-processed contextual analysis constructing an association tree by analyzing cluster of documents with same context as the original search phrase. Therefore, the advisory list provided in accordance to the disclosed invention is advantageous over prior art as it provides a finer resolution of suggested search phrases, based not only on the individual characteristics of the user performing the search, but also based on actual other similar users' associations when performing their own search. As clustering is performed as further disclosed in the invention, it is not even required that the same search phrases are used by different users, but rather that the search results and usage of information pages has similar attributes.

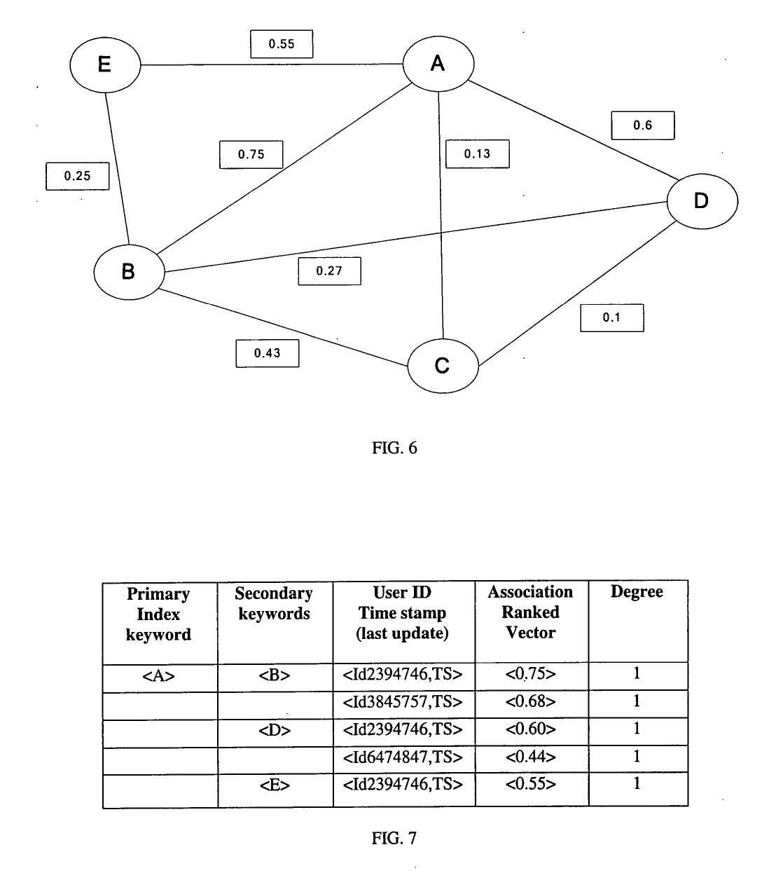

Reference is now made to FIG. 6, which shows an exemplary and non-limiting drawing of a compact association graph drawn. in accordance with the disclosed invention. Specifically, there is now shown a clustering process for user grouping and page collecting based on correlation between user association graphs and their shared interests. The example herein is further understood with respect to FIG. 7, which shows an exemplary and non-limiting table of the index word association. By arranging search phrases in the manner shown in FIGS. 6 and 7, it is aimed to correlate users based on similar associations regarding keywords and/or interests. The correlation performed in this manner results in a plurality of implicit user groups indexed under keywords and/or categories and/or interests, and the likes. By having strongly correlated user groups, it is possible to implicitly cause webpage, or information pages, clustering that is highly correlated with a specific user group. An association score is provided as a result of such analysis and which is explained in more detail below. Achieving such a correlation provides a clear advantage over prior art as it is now possible to provide to a user searching for information an information page to which most users of the type that user represents have gravitated. Moreover, it is a process in which URL's are matched directly against search phrases rather than merely single keywords. Therefore, a user will be directed to a page that a plurality of users having similar characteristics to that user and therefore being part of the same cluster, had an interest in such an information page. By performing the process dynamically, the system ensures that the correlation graphs keep updated, i.e., time sensitive. As a result information pages that have lost attractiveness over time, or users who have drifted away from an interest in a certain topic cluster, have a decayed level of influence over the provided results.

In another embodiment of the disclosed invention, not only a first level degree of clustering is performed but also clusters of clusters, providing further information on directing a searching user towards a more desirable search outcome. It may be further noticed with respect of the association graph that certain terms have more connections than others. For example, phrase B has the most connection, and therefore in this association graph is considered a peak. Above a certain threshold, peaks may be used for their dominancy in establishing their value for a user when searching for information. Moreover, comparison of such peaks across users can identify those search phrases having a higher importance. This can be done in various types of graphs for deducing a variety of importance conclusions.

Reference is again made to FIGS. 6 and 7. A plurality of key phrases is sent to a search engine, for example AAS server 210. The phrases A through F may be used by a plurality of users and over time correlations will be determined depending on the plurality of users who have sent such information. The association graph is comprised of nodes, a node also known as a vertex, and arcs connecting between nodes, or an arc within a node, an arc also known as an edge. As a result a correlation between each two search phrases will be determined. For example, the correlation between search phrase “A” and search phrase “B” is 0.75, while the correlation between search phrases “D” and “C” is 0.1. While a limited association graph is shown herein this should not be viewed as a limitation on the disclosed invention, and association graphs with degrees of distance larger than 2 are specifically included as part of the disclosure of this invention. For each search phrase that is part of user hotspot graph, an index is developed, an exemplary table of which is shown with respect to FIG. 7. A hotspot is a node on the graph that has a local peak above the other nodes of the graph. In the exemplary and non-limiting example of FIG. 6, nodes “A” and “B”, each having four arcs to other neighboring nodes, present such hotspots. The search phrase is provided with a grade that increases in value until it crosses a predetermine threshold. In one embodiment of the disclosed invention, this operation is done by an agent, for example agent 135. In another embodiment, the determination is performed as part of the operations performed by AAS server 210. While information is gathered on all valid search phrases, only those that have exceeded the predetermined threshold are actually used in the creation of the hotspots association graphs. The table then further includes the user identification associated with the specific user performing the search, followed by each and every of the search phrases associated with the root search phrase, in the case shown with respect to FIG. 7, the root being “A”. The distance from the root search phrase may be predetermined, and in the case of FIG. 7 is “2”, and therefore the association with search phrase “F” is also shown, the correlation being, for example, a convolution of the correlation between search phrase “A” and search phrase “B” by the correlation between search phrase “B” and search phrase “F”.

In accordance with the disclosed invention, a plurality of association graphs are created by the AAS server, for example AAS server 210. A personal association graph (PAG) is created for the association of keywords that are a result of the keywords used, or exposed to a user as a result of queries and responses thereto. A topic association graph (TAG) is created on a per topic bases, for example, the topic astronomy or the topic star. Topics may also be created from a combination of keywords, for example a topic which is the combination of astronomy+star. A global association graph (GAG) is also created and collects all the hotspots, or peaks, of all users. A document association graph (DAG) is created for each information page. The association graphs are used in a plurality of way in accordance with the disclosed invention to converge on search results that would be of more value to a searching user than others. The dynamic nature of the association graphs, that have decay functions to remove aging nodes and arcs, is fundamental to the continued learning process of the disclosed system.

In one embodiment of the disclosed invention, a clustering process will be performed from time-to-time. If an association surpasses the threshold for a cluster creation, the user list is copied into the specific cluster, where, for example, the association strength is the cluster internal order or rank. The user vector may include, but is not limited to, a user ID, an association grade, a time stamp for recent update, and the association words, as also shown with respect to FIG. 7. In one embodiment of the disclosed invention, universal resource locators (URLs) that were used to access information pages and that passed a threshold measuring the user's interaction level, influencing URL association graph, and were entered with same keyword core as the cluster ID may be also included. A person skilled in the art would realize that by performing this process periodically, it is possible to create a plurality of clusters while maintaining a compact representation of the information respective of the information pages and the users.

In accordance with the disclosed invention, the strength of association, or the association score, takes into consideration how balanced is the association between connected nodes and the actual score of the association edges. For example, if a-b-c is all connected, a-b score=1, b-c score=2, a-c score=9, this would mean that a-b-c is not a very strong triplet association concept. It is therefore that the solution must contain both factors into account. In accordance with the disclosed invention the association score will be:

$$association\_score = \frac{average\_edge \_score }{( 1 + \sqrt{var ( edge\_score )} )}$$

Using the example above average=4, var=[(1−4)ˆ2+(2−4)ˆ2+(9−4)ˆ2]/3=12.67, and as a result the association score will be:
Association score=4/(1+sqrt(12.67))=0.877

Notably, if a−b=1, b−c=1, a−c=1 then the association score=1, and if a−b=1 b−c=5 a−c=9 then association score=1.17. Hence, this function serves as a convolution between dual association score and their symmetry.

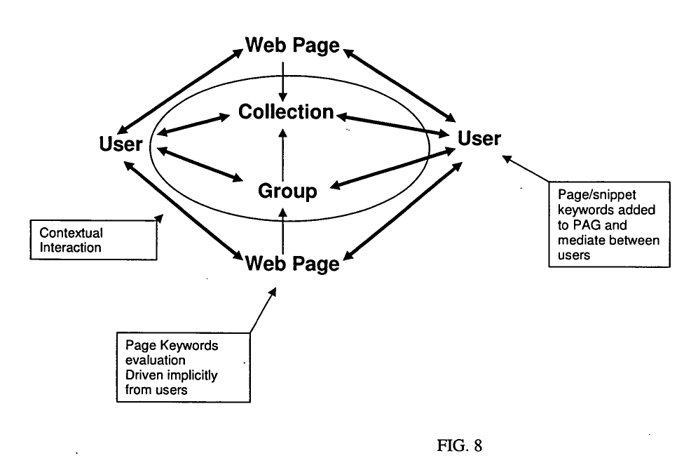

Reference is now made to FIG. 8, which shows an exemplary and non-limiting description of the relationships depicted in accordance with the disclosed invention. The user-document, also referred to as user-information page, interaction model operative in accordance with the invention operates where users are not merely information consumers but actually are valuable information suppliers. The supply of information may be direct, such as in the case of an explicit feedback, which tends also to be very limiting, or indirect, by means of actual measurement of the behavior of the user as an individual and as an individual within a plurality of clusters of other users, and by tagging the information pages. Moreover, a reverse relation may be also detected as knowledge is gained by the user and causes the update of his personal association graph (PAG). Clustering of information pages is based on the usage made by the users and by grouping users on the base of similarity of their hotpots within their association graphs. This handling is done automatically by the system and methods disclosed herein and therefore is influenced both by the more subjective taste of the individual user, as well as the more objective influence of the plurality of clusters of users and clusters of information pages. In order to quantify user-document interaction, it is necessary to use the same measurement attributes, thus, mapping the user attribute space and the document attribute space to identical vector space is essential. This mapping is achieved trough the creation of association graphs both for the user as for the URL's.

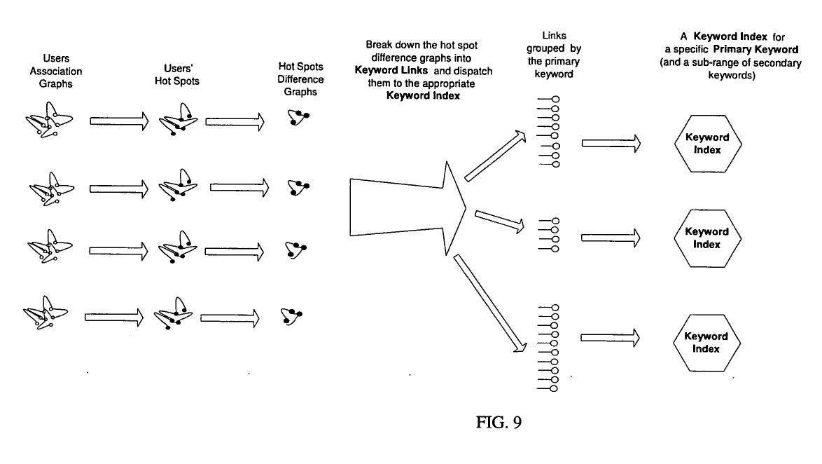

FIG. 9 shows the results of the various operations performed on the data resulting from the presentation of users' queries to a search engine operative in accordance with the disclosed invention. As noted above, a fundamental building block of the disclosed invention is the creation of association graphs. Based on the queries presented by the users and on significant keywords that were extracted from information pages that were visited with sufficient interaction, a plurality of PAGs are created. These are unique graphs to each of the users that actively use the system. In accordance with the disclosed invention, these association graphs have also a time value attribute and therefore may dynamically change as user shifts interests, increases or decreases interactivity with certain topics, as measured in respect to the keywords either used or exposed to the user, directly or indirectly. That is, a user may be using specific search phrases to reach certain information. However, that user may be also related to other queries that resulted in the same information but have used different keywords. In addition, with those information pages that the user interacted, will contribute additional keywords associated with the information page or document, causing a direct or indirect exposure to such keywords, and hence impacting the views the user will be presented with. In the creation of the PAGs as has also been discussed above there can be seen hotspots, or peaks, that are characterized by a node have more arcs then other nodes, or a node where the sum of the correlation between the nodes is higher than in other nodes. These hotspots are collected and can, based on the creation of hotspot difference graphs, allow the identification of primary keywords, i.e., keywords that are most valuable for the access to a specific information page. The operation for these creations is explained in more detail below.

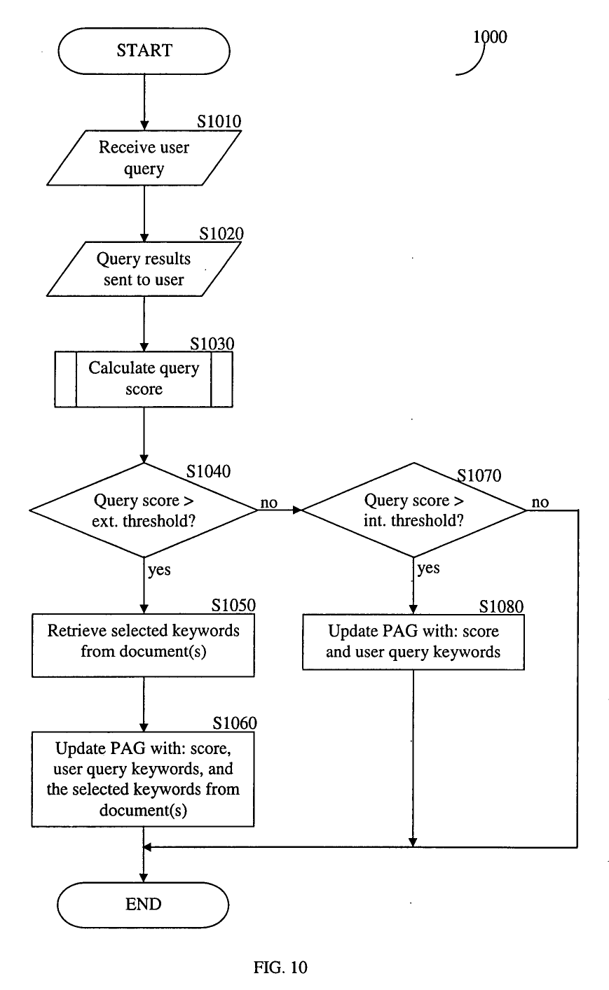

Reference is now made to FIG. 10, which shows an exemplary and non-limiting flowchart 1000 depicting the creation of a PAG. In step S1010 an AAS server, for example AAS server 210, receives a user query. In step S1010, the results of the query are sent to the user. The search engine may be an integral portion of the AAS server, or a service provided externally, using one or more of the available search engines. In step S1030 the query score is calculated. The score of a query represent the level of relevance of the query and its respective results to the searching user. The score can be based on a plurality of parameters, including access, time spent on the information page, interaction with the information page, and more. In step S1040 it is checked whether the query score exceeds an external threshold level. This threshold is devised so as to avoid accessing into the global system scores which may be of high relevance to a user but still insufficient to be of interest to a community of users. Therefore, if the query score exceeds the threshold execution continues with step S1050; otherwise, execution continues with step S1070. In step S1050 keywords associated with the information page are collected. This is important because they may including keywords not directly used by the user, however, they are important in the process of getting to the information page when searching for information. In step S1060 the PAG is updated with the query score, the user initiated keywords, and the keywords collected from the document. The updated PAG may now be checked again for hotspots and new results, also discussed above, may result. In step S1070 it is checked whether the query score is above an internal threshold. The internal threshold is intended to provide a filter against adding to the PAG queries of low importance to the user and impacting the effectiveness of the PAG. If the query score is above the internal threshold then execution continues with step S1080; otherwise, execution ceases. In step S1080 the PAG is updated with the score and the user keywords.

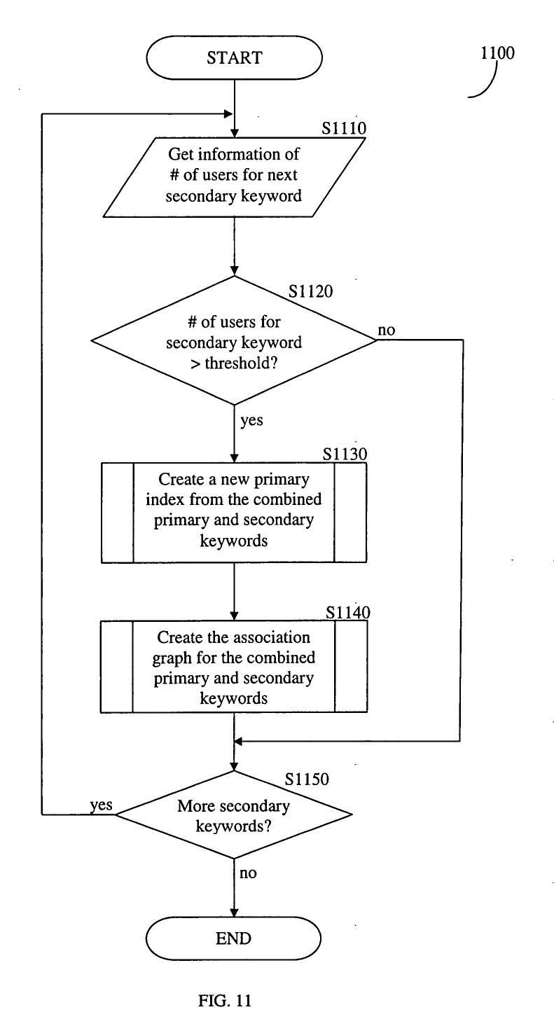

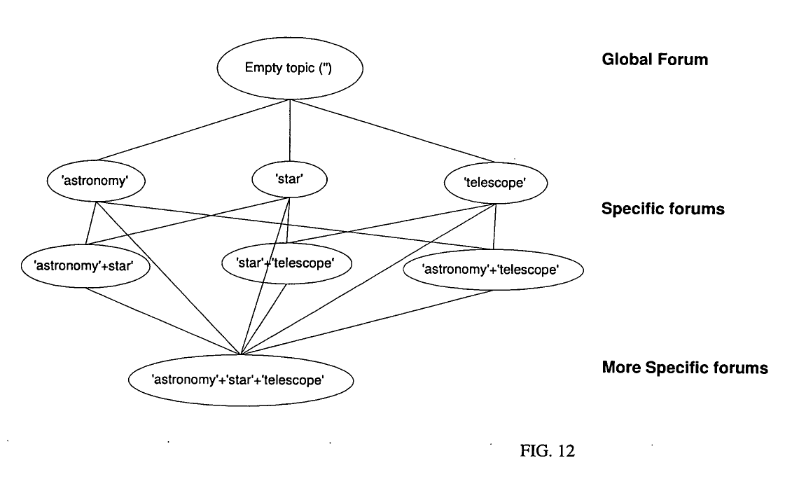

As noted above with reference to FIG. 7, a table containing primary and secondary indexes is prepared. When a sufficient number of users have been shown to interact with a secondary index, it would be beneficial to create a new primary index that is a combination of the primary and secondary index. The creating of such new primary indexes is shown with a flowchart in FIG. 11, and can be further understood with respect to FIG. 12. In accordance with the disclosed invention there is therefore a process whereby a repeated check of the primary index table, for example the table of FIG. 7, are checked periodically for the creation of new primary indexes. It should be also noted that nodes may lose this status as the entire system also has the aging capabilities, and therefore in the same manner in which secondary indexes, and user of the secondary index, are added, they may also diminish, and a removal may be necessary. In step S1110, the information of the number of users connected with a secondary keyword of the primary index table, such as in the table of FIG. 7, is gathered. Specifically, it will be the next secondary keyword in line to be processed. In step S1120 it is checked whether the number of users is above a predefined threshold value and if so execution continues with step S1130; otherwise, execution continues with step S1150. In step S1130 a new primary index is created from the combined primary and secondary keywords. Referring to FIG. 12, assuming astronomy is. a primary keyword, and star is a secondary keyword in the primary index table, such as the one shown in FIG. 7, then, if in that table where astronomy is a primary index and star is a secondary index, the number of users are above the threshold, a new primary index of the combination astronomy+star is created. For the newly created primary index there is created in step S1140 an association graph respective of the combined keywords. In step S1050 it is checked whether all the secondary keywords of the primary index table were checked and if affirmative execution is complete; otherwise, execution returns to step S1110 for continuation of this process.

As a result of the operations made with respect to the information collected from a plurality of users of the disclosed system there is rapidly established information that allows the system to provide advice to a searcher of information. Based on a query presented to the system, for example AAS server 210, advice is provided as a feedback to the user suggesting possible other queries and/or results based on other searches performed by other users of the system. Using the inventions disclosed herein, it is further possible to deduce that a query that may have different search phrases results in the same or closely related URLs and therefore these search phrases are also provided as advice information to the user.

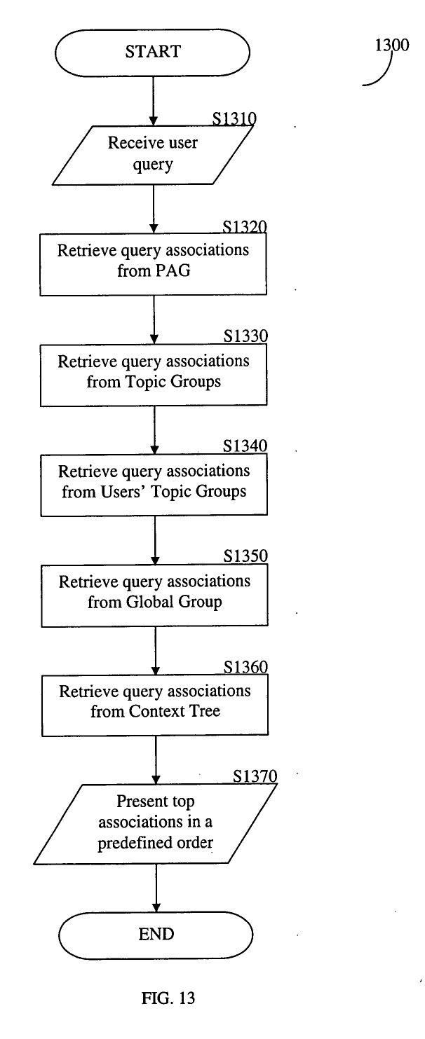

Reference is now made to FIG. 13, which shows an exemplary and non-limiting flowchart 1300 showing the process of providing keyword advice to a user. In step S1310 the user query is receive by the AAS server, for example AAS server 210. In steps S1320 through 1360 there are retrieved associations to the query from the user's PAG, TAGs, GAG, and the context tree. The top matches for advised keywords to be used are presented to the user in step S1370. Multiple techniques may be used to present the list, for example the top two from each of the sources, and then repeated by the following two from each of the sources, and so on and so forth. Other techniques include, but are not limited to, the creation of new a advisory graph by collecting the strongest association from each source. Other techniques may be applied without diverting from the scope of the disclosed invention, i.e., the use of association graphs to find keywords that would be of relevance to the user in the search of information, based on a query submitted by that user, and the collective learning over time made in accordance with the disclosed invention. Key to the invention of this advisory process is that it is based not on a mere textual analysis used in the prior art, but rather on actual collected and classified usage of the user as well as other similar users, in their pursuit of the sought for type of information.

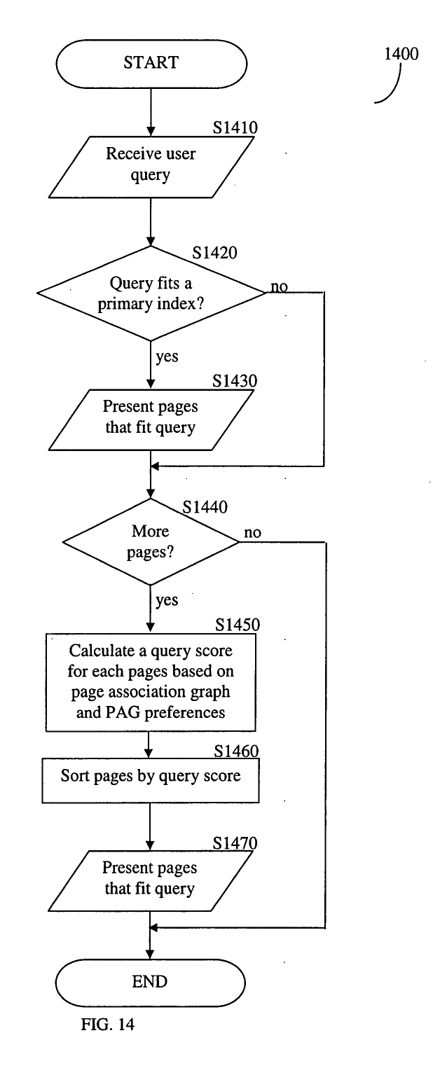

FIG. 14 shows an exemplary and non-limiting flowchart 1400 demonstrating another aspect of the use of the association graph for the purpose of ranking information pages in a manner tailored to the user. In step S1410 the user query is received by the AAS server, for example AAS server 210. In step S1420 it is checked whether the query fits a primary index and if it does execution continues with step S1430; otherwise, execution continues with step S1440. In step S1430 the information pages respective of the primary index are shown. In step S1440 it is checked whether additional pages are to be shown and if so execution continues with step S1450; otherwise, execution terminates. In step S1450 a query score is calculated for each information page based on its DAG. In step S1460 the relevant pages are sorted based on the score calculated, and in step S1470 the ranked list is displayed in descending order based on the page query score. Moreover, it is possible to personalize the ranking mechanism by factorizing, boosting or adding personal ranking that can contain a feedback mechanism to ensure correct manipulation of the queries as indicated above. For example, if a user uses a search phrase that includes the keywords quantum and mechanics, and in the user's PAG the keyword quantum is highly dominant, while the keyword mechanics is ranked low, then, pages with similar balance between the keywords quantum and mechanics as specifically demonstrated in that user's PAG will be ranked higher.

The use of the association graph is a powerful concept and merely a few examples of the use in respect of search engines have been shown herein, however, this should not be viewed as an intention to limit the scope of the invention. Other usages are possible, for example, using the PAG of a user to provide results for a search that includes keywords not used before by that user. As a result the user's PAG will seemingly not provide adequate information for better search results. However, it is possible to use the PAG of each user to create a personal vector that indicates the PAG correlation to all TAGs. By creating a space vector that is spanned from rather orthogonal TAGs and by mapping each user with a personal vector, one can achieve implicit clustering. It is then possible to cluster such vectors into vector groups, and as a result create a new users' association graph for all the users having vectors in a predefined proximity. Now, the query may be presented to that association graph that is likely to generate a better search response to the user's query.

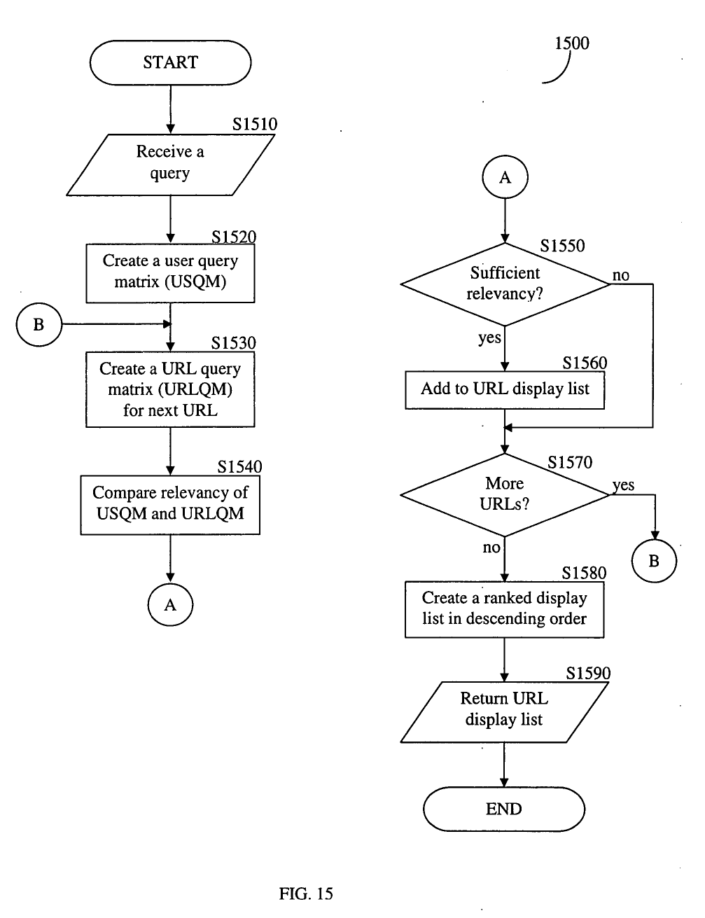

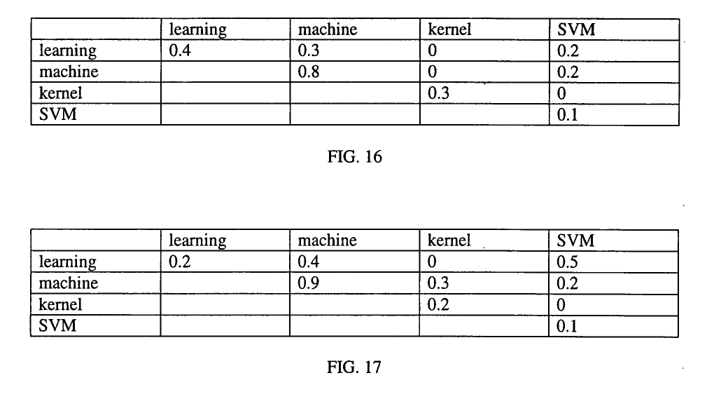

A non-limited example for the power of the use of association graphs as disclosed in the invention is shown with respect to the exemplary and non-limiting flowchart of FIG. 15, which can be further understood with respect to the exemplary and non-limiting matrices shown in FIGS. 16 and 17. When a query is presented to the search engine, an association graph is created from the PAG of the user and respective of the phrase used in the search. For example, if the search phrases are ‘learning’, ‘machine’, ‘kernel’ and ‘SVM’, a user query matrix (USQM) can be created as shown in the example of FIG. 16. Each URL may also have its own association graph (URLAG) that is created from keywords of the URL and that is updated continuously based on actual references to the URL. Therefore a URL query matrix (URLQM) can also be created by extracting the relevant phrases, and as can be seen with respect to FIG. 17, using the two matrices a relevancy is calculated between the two matrices. This is repeated for all relevant URLs and then a ranked list may be created, which may even include a relevancy threshold designed to omit those URLs having a lower than a predefined relevancy threshold to the query presented. It should be noted that if the phrase ‘learning machine’ becomes a topic, i.e., has a TAG, it will have a priority over the separate phrases as the phrase has shown strong relevancy.

FIG. 15 shows a flowchart 1500 where in step S1510 a query is received. In step S1520 a USQM is created for the query based on the PAG of the user submitting the search request. In step S1530 a URLQM is created based on the URLAG of the URL being checked. In step S1540 the relevancy between the matrices is calculated. An exemplary and non-limiting way to calculate relevancy, and assumptions thereof, for the calculation of such relevancy is discussed in more detail below. In step S1550 it is checked whether there is sufficient relevancy between the USQM and the URLQM and if so execution continues with step S1560; otherwise, execution continues with step S1570. In step S1560 the URL that has been found to be relevant to the query is added to a display list. Then, in step S1570, it is checked whether additional URLs are to be checked and if so, execution continues with step S1530; otherwise, execution continues with step S1580. In step S1580 a ranked list of the display list is created, typically in descending order of relevancy, i.e., those URLs having a higher level of relevancy are listed first. In step S1590 the ranked list is returned to the user performing the search.

In order to create an effective relevancy calculation certain assumptions may be necessary as explained herein. Firstly, is assumed that the matrices are symmetrical. The information respective of the secondary diagonal is most important because it provides information about pairs or topics rather than just single keywords. In one embodiment an influence weight is given to the search phrases based on the number of performed by the user in a given period of time. It should be further noticed that as data in intersection is farther away from the secondary diagonal, the importance of the correlation is lower. For example, with respect to FIG. 16 it means that the connection kernel-SVM is less important than the connection machine-learning. The weaker the score of any vertex or edge of the USQM, the weaker should be its influence on the correlation. That is, if nothing is known about the user regarding machine-learning it should not influence the relevancy score, as nothing definitive can be deduced from such score. However, if there is evidence of a strong connection then it will greatly influence the relevancy score. As for URLQM, when the score is low the association is not very strong, because multiple users' queries are used to reach this deduction. In other words it means that even when not knowing something about, for example machine-learning, there exists the knowledge of low correlation or relevancy.

Relevancy may be calculated according to the following exemplary and non-limiting discussion. Other relevancy scores, including correlations, may be developed and be equally applicable to the determination of the relevancy. Consider the association matrices of a query q=(w₁, . . . ,wᵣ) with respect to two agents η and ν: A_{η}(q)=B=(bᵢⱼ)_{1≦,i,j≦r}. The agent η is a set of users and the agent ν is a URL. It is desired to learn the relevancy of the URL ν to the users (or user) η using only matrices B and C. In accordance with the disclosed invention an estimation of the common interests of the users η and the surfers that reached that URL ν via queries takes place. Therefore, aspects in the association matrices that indicate clear directions of interest are to be sought. A frequent single word provides only vague information about the relevancy, two consecutive words that appear at a relatively high frequency contain much more information. As a general rule, the longer the search phrase, the more particular the content it carries from a statistical perspective. Accordingly the relevance that can be deduced from such a search phrase is higher. For practical reasons, but without limiting the general scope of the invention to two dimensional matrices, the example shown herein provides a two-dimensional information, and therefore is limited to pair of words.

A key element to the approach suggested in accordance with the disclosed invention is the significance of the frequency of a word or a search phrase, and more specifically two consecutive words as a matter of practice. This is reflected by the supposition that the matrices are normalized. Hence, a relevancy score may be obtained by using the following:

$${Rlevancy}_{query = q} ( user = u , URL ) = R ( B , C ) = {\sum }_{l \leq i \leq j \leq n} ( {w}_{u} ( i , j ) + λ ) \cdot {w}_{url} ( i , j ) \cdot {α}^{\vert j - l + 1 \vert}$$

while: λ=c·Eᵤ(wᵤ(i,j))

It should be noted that λ is representative of the personal correlation, thus, for rather low wᵤ(i,j), λ will be smaller, and for rather high wᵤ(i,j), λ will have stronger influence. This function contains a personal correlation factor:
λ=c·Eᵤ(wᵤ(i,j))

as well as a global correlation factor:

$${R}_{global} ( B , C ) = {\sum }_{l \leq i \leq j \leq n} ( {w}_{u} ( i , j ) \cdot {w}_{url} ( i , j ) \cdot {α}^{\vert j - l + 1 \vert}$$

Using a normalization factor it is further possible to tune the corresponding weights for the relevant score for the specific query provided by the user. A person skilled in the art would readily realize that the relevancy score may be further used to develop tailored advertising based on the methods disclosed herein.

A person skilled in the art would realize that the methods disclosed herein may be incorporated as part of a computer software program product. The computer software program product may contain a plurality of executable instruction, and/or a plurality of instructions for compilation by a compiler, and/or a plurality of instructions for interpretation by an interpreter, individually or in any combination thereof, designated for the execution of the methods disclosed hereinabove, or for the purpose of causing an AAS server, for example AAS sever 210, or a user system, for example, system 100, to be operative in accordance with the disclosed invention. Furthermore, the use of instruction is a mere example of a possible implementation, and hardware or a combination of hardware and software implementations of the disclosed invention is also envisioned and therefore should be considered as inseparable from the inventions herein. Furthermore, while the disclosed invention was described with respect to accessing of information pages that are essentially web pages, this invention should not be interpreted in such a limited scope. Other content, including but not limited to, e-mails, documents, presentations, databases, data files and the likes, may also be used in conjunction with the disclosed invention.

The inventions are provided, including, but not limited to, an auto-adaptive search server, a search engine, methods enabling the operation of multi-directional search engines, clustering methods thereof, creation of a plurality of association graphs and identification of peak terms therein, the relevancy score, and computer software products containing plurality of instructions for performing same, described in the Detailed Description of Embodiments.

A multi-directional and auto-adaptive relevance and search system is provided, comprising:

means for generating association graphs;

means for generating a query score;

means for comparing a query to an association graph; and

means for providing a response to a query comprised of a search phrase that is adapted to a user based on operations performed with respect to at least one association graph.

For some applications, said means for generating association graphs are enabled to generate at least one of: personal association graph, topic association graph, global association graph, document association graph.

For some applications, the search is performed on at least one of: web page, information page, document, e-mail, database.

For some applications, the system further comprises: means for identifying hotspots in an association graph.

For some applications, the system further comprises: means for generating an advice that comprises of keywords generated by means of at least an operation respective of an association graph.

For some applications, the system further comprises:

means for generating a plurality of primary indexes;

means for associating secondary indexes with respective primary indexes; and

means for associating users with said secondary indexes, and, optionally:

means for identifying that the number of users of a first secondary index exceeds a threshold value; and

means for creating a new primary index that is a combination of the primary index and said first secondary index.

A method is provided for generating a ranked display list of URLs based on the keywords from a user query, the method comprising the steps of:

receiving the search phrases of said user query;

creating a user query matrix based on the user's personal association graph and said search phrases;

for each URL found to be relevant to said user query create a URL query matrix;

computing the relevancy score of each URL query matrix to said user query matrix;

adding to a URL list the URLs with an associated relevancy score;

sorting the URL list in a descending order according to said relevancy score; and

sending the ordered list to said user.

For some applications, the method further comprises the step of: adding to said URL list those URLs having a relevancy score that is above a predetermined threshold value.

1-10. (canceled)

11. A computer-implemented method comprising:
generating at least one association graph;
receiving a search phrase from a user;
using the at least one association graph, generating a set of advisory keywords associated with the search phrase;
presenting the set of advisory keywords to the user;
responsively to a selection of at least one of the advisory keywords by the user, adding the selected at least one advisory keywords to the search phrase to generate a revised search phrase;
generating search results responsively to the revised search phrase; and
presenting the search results to the user.

12. The method according to claim 11, wherein generating the association graph comprises generating a personal association graph (PAG) that reflects associations of search keywords based on interactions of the user with information pages during previous searches performed by the user, and wherein generating the set of advisory keywords comprises generating the set of advisory keywords using the PAG.

13. The method according to claim 11, wherein the user is one of a plurality of users, wherein generating the association graph comprises generating a topic association graph (TAG) that reflects associations of search keywords relating to a single topic based on interactions of the plurality of users with information pages during previous searches performed by the users, and wherein generating the set of advisory keywords comprises generating the set of advisory keywords using the TAG.

14. The method according to claim 11, wherein the user is one of a plurality of users, wherein generating the association graph comprises generating a global association graph (GAG) that reflects associations of search keywords based on interactions of the plurality of users with information pages during previous searches performed by the users, and wherein generating the set of advisory keywords comprises generating the set of advisory keywords using the GAG.

15. The method according to claim 11, wherein generating the set of advisory keywords comprises generating the set of advisory keywords responsively to a level of association of the search phrase with the search keywords in the at least one association graph.

16. The method according to claim 11, wherein generating the set of advisory keywords comprises:
identifying a context of the search phrase;
constructing an association tree by analyzing clusters of documents having the same context as the search phrase; and
generating the set of advisory keywords using the at least one association graph and the association tree.

17. The method according to claim 11, wherein generating the set of advisory keywords comprises generating the set of advisory keywords using a plurality of association graphs, and wherein presenting the set of advisory keywords comprises presenting highest ranking advisory keywords from each of the association graphs.

18. The method according to claim 11,
wherein generating the search results comprises generating a list of relevant URLs of information pages, and
wherein presenting the search results to the user comprises:
creating a user query matrix based on the revised search phrase and a personal association graph (PAG) of the user that reflects associations of search keywords based on interactions of the user with information pages during previous searches performed by the user;
creating respective URL query matrices for the relevant URLs;
computing respective relevancy scores of each of the URL query matrices to the user query matrix;
sorting the list of relevant URLs in descending order according to the respective relevancy scores; and
presenting at least a top-ranked portion of the ordered URL list to the user.

19. Apparatus comprising:
an interface for communicating with a user; and
a processor, which is configured to generate at least one association graph; receive a search phrase from a user, via the interface; using the at least one association graph, generate a set of advisory keywords associated with the search phrase; present the set of advisory keywords to the user, via the interface; responsively to a selection of at least one of the advisory keywords by the user, add the selected at least one advisory keywords to the search phrase to generate a revised search phrase; generate search results responsively to the revised search phrase; and present the search results to the user, via the interface.

20. The apparatus according to claim 19, wherein the processor is configured to generate a personal association graph (PAG) that reflects associations of search keywords based on interactions of the user with information pages during previous searches performed by the user, and to generate the set of advisory keywords using the PAG.

21. The apparatus according to claim 19, wherein the user is one of a plurality of users, and wherein the processor is configured to generate a topic association graph (TAG) that reflects associations of search keywords relating to a single topic based on interactions of the plurality of users with information pages during previous searches performed by the users, and to generate the set of advisory keywords using the TAG.

22. The apparatus according to claim 19, wherein the user is one of a plurality of users, and wherein the processor is configured to generate a global association graph (GAG) that reflects associations of search keywords based on interactions of the plurality of users with information pages during previous searches performed by the users, and to generate the set of advisory keywords using the GAG.

23. The apparatus according to claim 19, wherein the processor is configured to generate the set of advisory keywords responsively to a level of association of the search phrase with the search keywords in the at least one association graph.

24. The apparatus according to claim 19, wherein the processor is configured to generate the set of advisory keywords by: identifying a context of the search phrase, constructing an association tree by analyzing clusters of documents having the same context as the search phrase, and generating the set of advisory keywords using the at least one association graph and the association tree.

25. The apparatus according to claim 19, wherein the processor is configured to generate the set of advisory keywords using a plurality of association graphs, and to present highest ranking advisory keywords from each of the association graphs.

26. The apparatus according to claim 19, wherein the processor is configured to generate a list of relevant URLs of information pages, and to present the search results to the user by: creating a user query matrix based on the revised search phrase and a personal association graph (PAG) of the user that reflects associations of search keywords based on interactions of the user with information pages during previous searches performed by the user, creating respective URL query matrices for the relevant URLs, computing respective relevancy scores of each of the URL query matrices to the user query matrix, sorting the list of relevant URLs in descending order according to the respective relevancy scores, and presenting at least a top-ranked portion of the ordered URL list to the user.

27. A computer software product, comprising a tangible computer-readable medium in which program instructions are stored, which instructions, when read by a computer, cause the computer to generate at least one association graph; receive a search phrase from a user; using the at least one association graph, generate a set of advisory keywords associated with the search phrase; present the set of advisory keywords to the user; responsively to a selection of at least one of the advisory keywords by the user, add the selected at least one advisory keywords to the search phrase to generate a revised search phrase; generate search results responsively to the revised search phrase; and present the search results to the user.

28. The computer software product according to claim 27, wherein the instructions, when read by the computer, cause the computer to generate a personal association graph (PAG) that reflects associations of search keywords based on interactions of the user with information pages during previous searches performed by the user, and to generate the set of advisory keywords using the PAG.

29. The computer software product according to claim 27, wherein the user is one of a plurality of users, and wherein the instructions, when read by the computer, cause the computer to generate a topic association graph (TAG) that reflects associations of search keywords relating to a single topic based on interactions of the plurality of users with information pages during previous searches performed by the users, and to generate the set of advisory keywords using the TAG.

30. The computer software product according to claim 27, wherein the user is one of a plurality of users, and wherein the instructions, when read by the computer, cause the computer to generate a global association graph (GAG) that reflects associations of search keywords based on interactions of the plurality of users with information pages during previous searches performed by the users, and to generate the set of advisory keywords using the GAG.

31. The computer software product according to claim 27, wherein the instructions, when read by the computer, cause the computer to generate the set of advisory keywords responsively to a level of association of the search phrase with the search keywords in the at least one association graph.

32. The computer software product according to claim 27, wherein the instructions, when read by the computer, cause the computer to generate the set of advisory keywords by: identifying a context of the search phrase, constructing an association tree by analyzing clusters of documents having the same context as the search phrase, and generating the set of advisory keywords using the at least one association graph and the association tree.

33. The computer software product according to claim 27, wherein the instructions, when read by the computer, cause the computer to generate the set of advisory keywords using a plurality of association graphs, and to present highest ranking advisory keywords from each of the association graphs.

34. The computer software product according to claim 27, wherein the instructions, when read by the computer, cause the computer to generate a list of relevant URLs of information pages, and to present the search results to the user by: creating a user query matrix based on the revised search phrase and a personal association graph (PAG) of the user that reflects associations of search keywords based on interactions of the user with information pages during previous searches performed by the user, creating respective URL query matrices for the relevant URLs, computing respective relevancy scores of each of the URL query matrices to the user query matrix, sorting the list of relevant URLs in descending order according to the respective relevancy scores, and presenting at least a top-ranked portion of the ordered URL list to the user.
